(19) United States
(12) Patent Application Publication
(10) Pub. No.: US 2010/0112342 A1
(43) Pub. Date: May 6, 2010

(54) SUBSTRATE FOR BIOCHIP AND METHOD OF MANUFACTURING THE SUBSTRATE

(75) Inventor: Seong-ho CHO, Gwacheon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Gyeonggi-do (KR)

(21) Appl. No.: 12/610,429

(22) Filed: Nov. 2, 2009

(30) Foreign Application Priority Data
Nov. 5, 2008 (KR) 10-2008-0109466

(51) Int. Cl. B32B 9/00; B44C 1/22

(52) U.S. Cl. 428/338; 216/41

(57) ABSTRACT

A substrate for a biochip and a method of manufacturing the substrate. The substrate for a biochip having nanostructured spots formed on a base to which probe biomolecules are attached are, improving the binding efficiency between the substrate and the spots, and improving the efficiency in the detection of the biomolecules as well.

### CROSS-REFERENCE TO RELATED APPLICATIONS

This application claims priority to Korean Patent Application No. 10-2008-0109466, filed on Nov. 5, 2008, and all the benefits accruing therefrom under 35 U.S.C. §119, the content of which in its entirety is herein incorporated by reference.

### BACKGROUND

1. Field

One or more embodiments of the invention relate to a substrate for a biochip, the substrate including nanostructured spots, and a method of manufacturing the substrate.

2. Description of the Related Art

As genome projects have progressed, nucleotide sequences of genomes have been identified from various organisms. With the information available about the identified nucleotide sequences, gene expression profiles and the function of gene products has been actively studied.

Biochips are biometric devices made by combining biological materials such as enzymes, peptides, proteins, antibodies, and deoxyribonucleic acids (DNAs) of living creatures, microorganisms, and cells, organs, and nerves of animals and plants into a microchip similar to a semiconductor chip. The advent of biotechnology, nanotechnology using a semiconductor process, and micro electro mechanical system (“MEMS”) technology has accelerated the development of biochips.

Protein chips and DNA chips consisting of microarrays are likely to be commercialized soon. DNA chips are devices for detecting DNAs. DNA chips are made by arranging probe DNAs including several hundred to several ten million DNAs having known sequence and/or function in a small area on a substrate, such as a glass substrate or a semiconductor substrate. When genetic material of a sample is dropped onto such a DNA chip to which probe DNAs are attached, only genes corresponding to the probe DNAs, i.e., only genes having complementary sequences to base sequences of the probe DNAs, are combined with the probe DNAs. Genes that are not combined with the probe DNAs are washed away. Since the sequence and/or function of the base sequences of probe DNAs arranged on the DNA chip are already known, genetic information of the sample may be easily obtained by identifying bases combined with genes in the DNA chip. Accordingly, aspects of a unique genetic expression, single nucleotide polymorphisms and copy number variation in a gene, or mutation in a cell or tissue may be quickly analyzed using the DNA chip. Furthermore, the DNA chip may also be used to analyze genetic expression, or used for pathogenic bacteria infection tests, antibiotic-resistance tests, research on biological reaction to environmental factors, food safety inspections, identification of criminals, development of new drugs, medical inspection of animals and plans, etc.

Biochips having probe biomolecules attached to a substrate are formed by synthesizing single stranded DNAs on a desired area of the substrate or by spotting prefabricated single or double stranded DNAs onto a selected area of the substrate. However, it is difficult to control the density of spots of biomolecules attached to the substrate, thereby failing to make a precise analysis.

### SUMMARY

According to one or more embodiments of the invention, a substrate for a biochip, the substrate including: a base, a plurality of spots to which a plurality of biomaterials is attached, wherein each of the plurality of spots includes a plurality of sub spots.

In one embodiment, each of the plurality of sub spots may have a shape with a side of about 1 nm to about 1 μm in length.

In another embodiment, each of the plurality of sub spots may have a shape with a side of about 1 nm to about 500 nm in length.

In another embodiment, a distance between the sub spots may range from about 1 nm to about 1 μm.

In another embodiment, each of the plurality of sub spots may have any shape selected from the group consisting of an oval shape, a polygonal shape, a starfish-like shape, a toothed wheel-like shape, and a clover-like shape,

According to one or more embodiments, each of the plurality of sub spots may be hydrophilic, and the base may be hydrophobic or the plurality of sub spots and the base may be hydrophilic in which biomolecules are grown only on the lithographically patterned sub spots region.

According to one or more embodiments, each of the plurality of sub spots may be formed of any one selected from the group consisting of an oxide, a dielectric material, a polymer, a semiconductor material and any combinations thereof.

According to one or more embodiments of the invention, a method of manufacturing a substrate for a biochip, the method including: applying a sub spot forming material to a substrate to form a sub spot material layer; applying a photoresist on the sub spot material layer and performing lithography to form photoresist (PR) patterns; and etching portions of the sub spot material layer which are not covered by the PR patterns to form a plurality of sub spots.

In one embodiment, the sub spot forming material may be any one selected from the group consisting of an oxide, a dielectric material, a polymer, and a semiconductor material, and any combinations thereof.

In another embodiment, the lithography may use any one selected from the group consisting of i-line, KrF, ArF, F2, extreme ultraviolet (EUV) light, X-ray, and electron beam.

In another embodiment, the lithography may use a mask having a plurality of serifs.

In another embodiment, the lithography may be any one selected from the group consisting of maskless lithography, nanoimprint lithography, spacer lithography, and immersion lithography.

In another embodiment, the etching of the portions of the sub spot material layer may include etching the portions of the sub spot material layer using dry etching or wet etching; and if an interlayer between PR and the sub spot material should be introduced, the interlayer material patterned and etched using PR can provide a secondary layer of mask, so called hard mask, in order to make a finer structure for the sub spot material than PR patterning.

Accordingly, the uniformity and the density of biomolecules attached to the biochip may be improved, and thus the reliability of data derived from detection may be improved. Furthermore, the substrate for the biochip may be mass-produced using a semiconductor process, and thus economic efficiency may be improved.

One or more embodiments of the invention are not limited to the embodiments described above, and may also include other embodiments. These and other embodiments and features of the invention will become more fully apparent from the following description or may be learned by practice of the illustrated embodiments, as will be apparent to those of ordinary skill in the art.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic diagram illustrating a top plan view of an exemplary embodiment of a substrate for a biochip according to the invention;

FIG. 2 is a schematic diagram illustrating a top plan view illustrating sub spots of the substrate of FIG. 1;

FIG. 3 is a diagram illustrating a side view of an exemplary embodiment of sub spots of the substrate of FIG. 1;

FIG. 4 illustrates exemplary shapes of sub spots of the substrate of FIG. 1;

FIGS. 5A through 5F are schematic diagrams illustrating cross-sectional views of an exemplary embodiment of a method of manufacturing a substrate for a biochip, according to the invention;

FIG. 6A is a schematic diagram illustrating a cross-sectional view of an exemplary embodiment of sub spots formed by dry etching;

FIG. 6B is a schematic diagram illustrating across-sectional view illustrating of an exemplary embodiment of sub spots formed by wet etching;

FIG. 7 is a schematic diagram illustrating a mask having serifs.

### DETAILED DESCRIPTION

Reference will now be made in detail to embodiments, examples of which are illustrated in the accompanying drawings. The sizes of elements and layers in the drawings are exaggerated for clarity. In this regard, the illustrated embodiments may have different forms and should not be construed as being limited to the descriptions set forth herein. Accordingly, the embodiments are merely described below, by referring to the figures, to explain features of the description.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “under” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “under” relative to other elements or features would then be oriented “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings.

In one embodiment, a substrate for a biochip comprising a base, a plurality of spots, wherein each of the plurality of spots includes a plurality of sub spots, the sub spots have a plurality of biomaterials attached thereto.

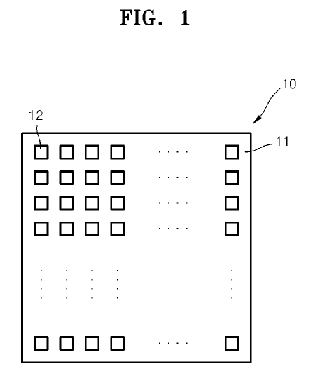

FIG. 1 is a schematic diagram illustrating a top plan view of an embodiment of a substrate 10 for a biochip according to the invention.

Referring to FIG. 1, the substrate 10 includes a base 11 and a plurality of spots 12 formed on the base 11. Biomolecules having the same base sequences, for example, probe DNAs, are attached to the plurality of spots 12. The base sequences for probe DNAs attached to the plurality of spots 12 may be the same or different for individual spots.

In one embodiment, the base 11 of the substrate 10 may be a flexible substrate or a rigid substrate. For example, the base 11 may be formed of silicon, glass or plastic. Generally, the base 11 is formed of a hydrophobic material such that biomolecules are not attached to the base 11.

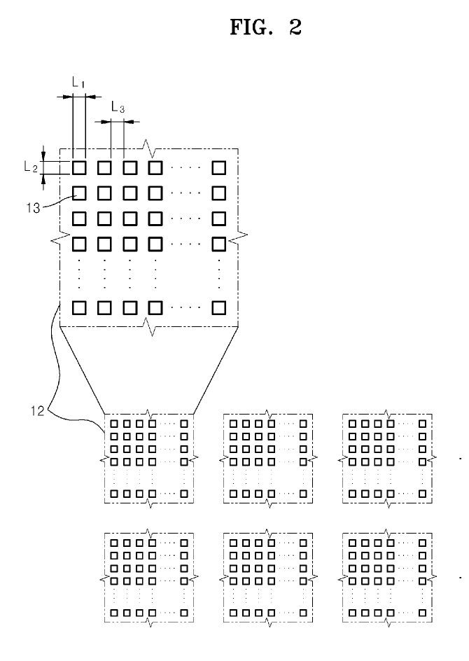

In one embodiment, each of the plurality of spots 12 includes an array of sub spots 13. FIG. 2 is a top plan view illustrating sub spots 13 of the plurality of spots 12 of the substrate 10 of FIG. 1. Biomolecules having the same base sequences, for example, probe DNAs, are attached to the array of sub spots 13. The base sequences for probe DNAs attached to the sub spots 13 may be the same or different for individual sub spots.

Referring to FIG. 2, each of the plurality of spots 12 of the substrate 10 includes an array of sub spots 13. In one embodiment, each of the sub spots 13 may have a rectangular shape with a side of about 1 nm to about 1 μm in length, and the number of the sub spots 13 is not limited. For example, if each of the plurality of sub spots 13 has a rectangular shape, two sides L₁ and L₂ of each of the plurality of sub spots 13 may be equal to each other (L₁=L₂), or either one of the two sides L₁ and L₂ may be greater than the other (L₁>L₂, L₁<L₂). Both the size of each of the plurality of sub spots 13 and the distance L₃ between the sub spots 13 may range from about 1 nm to about 1 μm.

According to one or more embodiments, the sub spots 13 may be formed of an oxide, a dielectric material, a polymer or a semiconductor material. Generally, the sub spots 13 may be formed of a hydrophilic material such that biomolecules may attach to the sub spots 13. As noted above, the base 11 is hydrophobic such that biomolecules are not attached to the base 11, and the sub spots 13 are hydrophilic such that biomolecules are attached to the sub spots 13. In contrast, if the base 11 is hydrophilic and the sub spots 13 are hydrophobic, biomolecules may be distributed between the sub spots 13 on the base 11. In another embodiment, the entire substrate 10, both the plurality of sub spots 13 and the base 11 may be hydrophilic in which biomolecules are grown only on the lithographically patterned sub spots region.

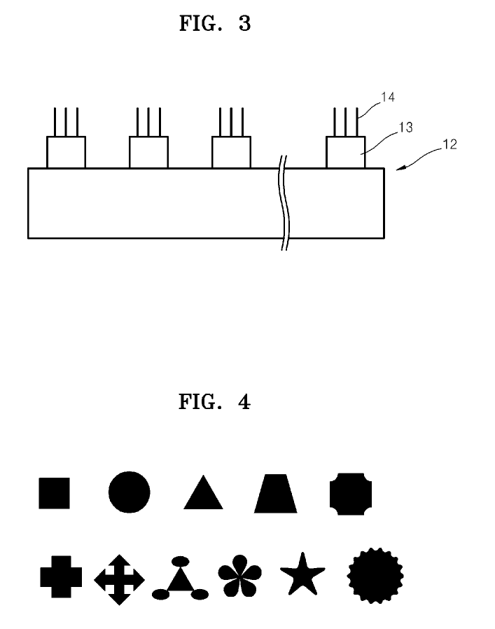

FIG. 3 is a diagram illustrating a side view of an embodiment of sub spots 13 of the substrate 10 of FIG. 1. Referring to FIG. 3, the plurality of sub spots 13 are formed on the base 11. Biomolecules 14 are to be attached to the plurality of sub spots 13 when the biochip is formed.

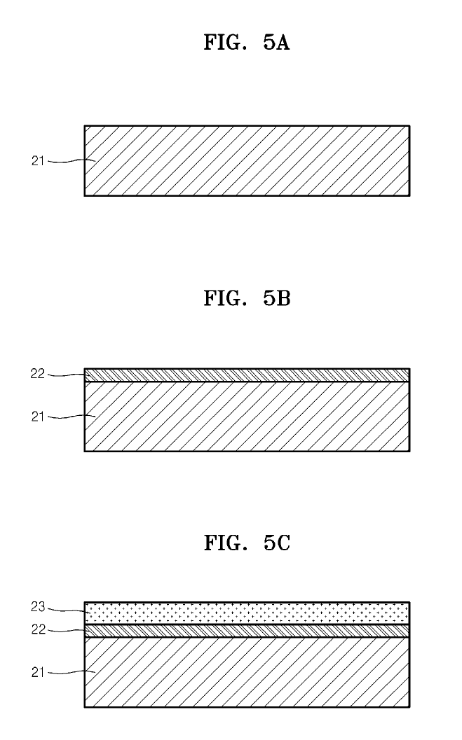

Although each of the plurality of sub spots 13 has a rectangular shape in FIG. 2, the invention is not limited thereto, and each of the plurality of sub spots 13 may have an oval shape, a polygonal shape, a starfish-like shape, a toothed wheel-like shape, a clover-like shape, or the like as shown in FIG. 4. The shape of each of the plurality of sub spots 13 may vary depending on the shape of a mask or an etching method used when forming the plurality of sub spots 13, which will be explained later in detail.

As described above, the substrate 10 includes the plurality of spots 12 including the plurality of sub spots 13 each of which has a size of about 1 nm to about 1 μm. Accordingly, since the area of each of the sub spots 13 to which biomolecules are attached is much smaller than the surface area of each of the plurality of spots 12, an electrostatic force is increased, thereby leading to active binding between biomolecules and the sub spots 13. That is, unlike a substrate for a biochip which includes one flat spot, since each of the plurality of spots 12 includes the plurality of sub spots 13, conjugation, binding, and linking of biomolecules may be improved.

Since the typical substrate includes one flat spot, a biomolecule density difference between positions on the spot is high. However, since the substrate 10 of FIG. 1 may significantly increase a binding force between the plurality of sub spots 13 and biomolecules, a uniform biomolecule density may be achieved. Accordingly, when probe biomolecules and target biomolecules are hybridized and then the target biomolecules are analyzed using either an electrical detection or a fluorescence imaging, data variation according to the position of an image on the spots may be reduced.

In one embodiment, each of the plurality of sub spots 13 has a feature size smaller than a fluorescent wavelength A, for example, each having a diameter of about 1 nm to about 500 nm that is smaller than the fluorescence wavelength. If each of the plurality of sub spots 13 has a feature size smaller than a fluorescent wavelength A, for example, 500 nm, and has a diameter of about 1 nm to about 500 nm that is smaller than the fluorescence wavelength, a scanner reads an average of data of neighboring sub spots, not individual data of one sub spot in an optical detection process. Accordingly, non-uniformity among neighboring sub spots in one spot may be reduced. Accordingly, the size and the shape of each of the plurality of sub spots 13 may be properly adjusted considering various fluorescent wavelengths.

In one embodiment, a method of manufacturing a substrate for a biochip, the method comprising applying a sub spot forming material to a substrate to form a sub spot material layer; applying a photoresist on the sub spot material layer and performing lithography to form photoresist (PR) patterns; and etching portions of the sub spot material layer which are not covered by the PR patterns to form a plurality of sub spots.

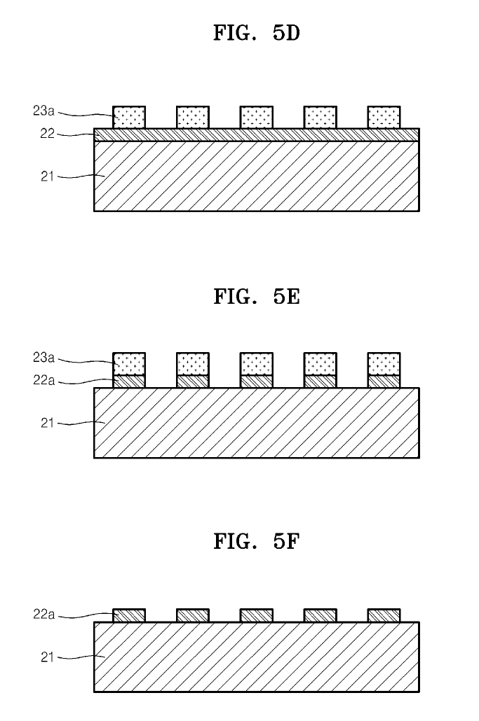

FIGS. 5A through 5G are schematic diagrams illustrating cross-sectional views illustrating an exemplary embodiment of method of manufacturing a substrate for a biochip, according to an embodiment of the present invention.

Referring to FIG. 5A, a base 21 is prepared. The base 21 may be a formed with flexible substrate or a rigid substrate. For example, the base 21 may be formed of silicon, glass or plastic.

Referring to FIG. 5B, a sub spot material layer 22 is formed on the base 21. The sub spot material layer 22 may be formed of a dielectric material, a polymer or a semiconductor material. Either the base 21 or the sub spot material layer 22 may be hydrophilic and the other may be hydrophobic by controlling materials of the base 21 and the sub spot material layer 22. Accordingly, biomolecules may be attached to or between sub spots. In another embodiment, both the sub spot material layer 22 and the base 21 may be hydrophilic in which biomolecules are grown only on the lithographically patterned sub spots region.

Referring to FIG. 5C, a photoresist layer 23 is applied to the sub spot material layer 22. Referring to FIG. 5D, the photoresist layer 23 is patterned by photolithography to form photoresist (PR) patterns 23a. The photoresist 23 may be patterned by photolithography using a mask, maskless lithography, nanoimprint lithography, spacer lithography, or immersion lithography, which generally uses i-line, KrF, ArF, F2, extreme ultraviolet (EUV), X-ray, or electron beam. If an interlayer between PR and the sub spot material should be introduced, the interlayer material patterned and etched using PR can provide a secondary layer of mask, so called hard mask, in order to make a finer structure for the sub spot material than PR patterning.

Referring to FIGS. 5E and 5F, portions of the sub spot material layer 22 which are not covered by the PR patterns 23a are etched to form a plurality of sub spots 22a. The size and the shape of each of the plurality of sub spots 22a may vary depending on an etching method. For example, dry etching, e.g., reactive ion etching (RIE), having directivity may be performed. Further, as exemplified in FIG. 3, the method may further comprise attaching biomolecules 14 to the plurality of sub spots 13 (not shown in FIG. 5).

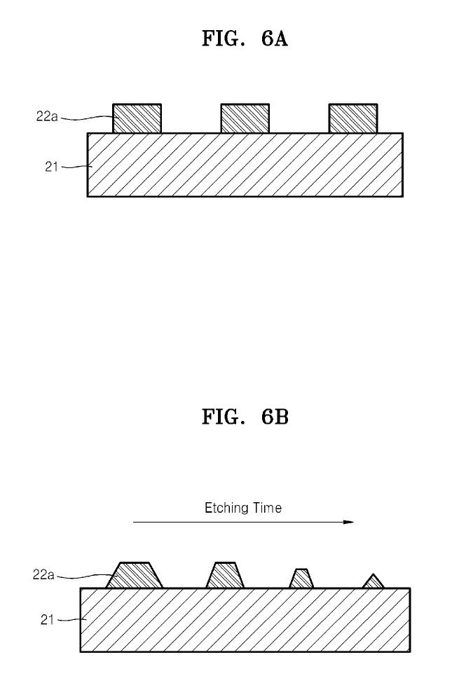

FIG. 6A is a cross-sectional view illustrating sub spots 22a formed by dry etching. Referring to FIG. 6A, if etching is vertically performed, top surfaces of the sub spots 22a on which the PR patterns 23a are formed are not affected by an etching time. FIG. 6B is a cross-sectional view illustrating sub spots 22a formed by we etching. However, referring to FIG. 6B, if wet etching is isotropically performed, top surfaces of the sub spots 22a are not protected by the PR patterns 23a and are etched as an etching time increases. That is, as shown in FIG. 6B, in the case of wet etching, as the etching time increases, the size of each of the sub spots 22a is reduced, the surface area of each of the sub spots 22a is reduced, and finally a flat surface of each of the sub spots 22a is etched away and thus removed. That is, the size and the shape of each of the sub spots 22a vary depending on an etching method and an etching time as well as lithography.

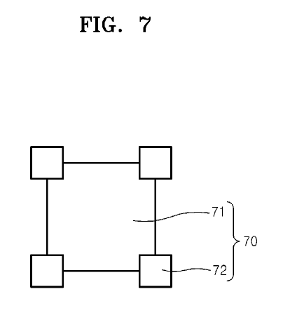

FIG. 7 is a schematic view illustrating a mask 70 having a plurality of serifs 72. In order to form sub spots having various shapes as shown in FIG. 4, the mask 70 including a mask pattern 71 and the plurality of serifs 72 as shown in FIG. 7, which are added to the mask pattern 71 for the purpose of optical proximity correction, as one pattern may be used. Accordingly, the size and the shape of each of the sub spots and spacing between the sub spots may be controlled using the mask 70. The size and the shape of each of the sub spots and the spacing between the sub spots determined using the mask 70 may affect binding stability between a substrate for a biochip and biomolecules in a subsequent process and a signal to noise ratio (SNR) in a detection process.

As described above, each of the sub spots of the substrate for the biochip according to the one or more embodiments of the present invention has a shape with a side of about 1 nm to about 1 μm in length. The size of each of the sub spots may be adjusted considering the fluorescent wavelength of fluorescence that is present in sample genes to be attached to the biochip and is emitted when being excited.

While one or more embodiments of the present invention have been particularly shown and described it will be understood by those of ordinary skill in the art that various modifications in form and detail may be made therein without departing from the spirit and scope of the teachings of the present invention as defined by the following claims. The exemplary embodiments should be considered in a descriptive sense only and not for purposes of limitation. Therefore, all such modifications are intended to be included within the scope of the claims.

What is claimed is:

1. A substrate for a biochip, the substrate comprising:
a base,
a plurality of spots to which a plurality of biomaterials are attached formed on a base,
wherein each of the plurality of spots comprises a plurality of sub spots.

2. The biochip of claim 1, wherein each of the plurality of sub spots has a shape with a side of about 1 nm to about 1 μm in length.

3. The biochip of claim 2, wherein each of the plurality of sub spots has a shape with a side of about 1 nm to about 500 nm in length.

4. The biochip of claim 1, wherein the distance between the sub spots ranges from about 1 nm to about 1 μm.

5. The biochip of claim 1, wherein each of the plurality of sub spots has any one selected from the group consisting of an oval shape, a polygonal shape, a starfish-like shape, a toothed wheel-like shape and a clover-like shape.

6. The biochip of claim 1, wherein each of the plurality of sub spots is hydrophilic, and the base is hydrophobic.

7. The biochip of claim 1, wherein both the plurality of sub spots and the base are hydrophilic.

8. The biochip of claim 1, wherein each of the plurality of sub spots is formed of any one selected from the group consisting of an oxide, a dielectric material, a polymer, a semiconductor material and any mixtures thereof.

9. A method of manufacturing a substrate for a biochip, the method comprising:
applying a sub spot forming material to a base to form a sub spot material layer;
applying a photoresist on the sub spot material layer and performing lithography to form photoresist (PR) patterns; and
etching portions of the sub spot material layer which are not covered by the PR patterns to form a plurality of sub spots.

10. The method of claim 9, wherein the sub spot forming material is any one selected from the group consisting of an oxide, a dielectric material, a polymer, and a semiconductor material, and any combinations thereof.

11. The method of claim 9, wherein the lithography uses any one selected from the group consisting of i-line, KrF, ArF, F2, extreme ultraviolet (EUV) light, X-ray, and electron beam.

12. The method of claim 9, wherein the lithography uses a mask having a plurality of serifs.

13. The method of claim 9, wherein the lithography is any one selected from the group consisting of maskless lithography, nanoimprint lithography, spacer lithography and immersion lithography.

14. The method of claim 9, wherein each of the plurality of sub spots has a shape with a side of about 1 nm to about 1 μm in length.

15. The method of claim 9, wherein each of the plurality of sub spots has a shape with a side of about 1 nm to about 500 nm in length.

16. The method of claim 9, wherein the distance between the sub spots ranges from about 1 nm to about 1 μm.

17. The method of claim 9, wherein the etching of the portions of the sub spot material layer comprises etching the portions of the sub spot material layer using dry etching or wet etching.

18. The method of claim 9, wherein an interlayer is introduced between PR and the sub spot forming material.

19. The method of claim 9, further comprising attaching a plurality of biomolecules to the sub spots.

20. A substrate for a biochip, the substrate comprising:
a base,
a plurality of spots formed on a base,
wherein each of the plurality of spots comprises a plurality of sub spots, and
wherein sub spots have a plurality of biomaterials are attached thereto.
